(19) United States
(12) Patent Application Publication
(10) Pub. No.: US 2017/0106636 A1
(43) Pub. Date: Apr. 20, 2017

(54) WINDOWS FOR DISPLAY DEVICE AND DISPLAY DEVICE INCLUDING THE SAME

(71) Applicants: SAMSUNG ELECTRONICS CO., LTD., Suwon-si (KR); SAMSUNG SDI CO., LTD., Yongin-si (KR)

(72) Inventors: A Ra JO, Euiwang-si (KR); Chanjae AHN, Suwon-si (KR); Sungwon CHOI, Hwaseong-si (KR); Byunghee SOHN, Yongin-si (KR); Seung Bum Joseph CHUN, Seongnam-si (KR); Sung Woo HONG, Seoul (KR); Junghwa KIM, Yongin-si (KR); Da Eun YU, Suwon-si (KR)

(21) Appl. No.: 15/212,785

(22) Filed: Jul. 18, 2016

(30) Foreign Application Priority Data
Oct. 14, 2015 (KR) 10-2015-0143522

(51) Int. Cl. B32B 27/34; B32B 27/38; B32B 27/28

(52) U.S. Cl. CPC B32B 27/34; B32B 27/281; B32B 27/38; B32B 2307/536; B32B 2457/00; B32B 2255/00

(57) ABSTRACT

A window for a display device including: a plastic substrate including a poly(imide-amide) copolymer, which is a reaction product of a reagent combination of 4,4′-hexafluoroisopropylidene diphthalic anhydride, 3,3′,4,4′-biphenyltetracarboxylic dianhydride, 2,2′-bis-trifluoromethyl-4,4′-biphenyldiamine, and terephthaloyl chloride, and a hard coating layer disposed on at least one side of the plastic substrate, wherein the plastic substrate has pencil scratch hardness of greater than or equal to 3H when measured according to an ASTM D3363 standard at a vertical load of about 0.5 kilograms, and a peak intensity ratio A2/A1 of a peak intensity A2 at a position of about 23.5° in 2θ to a peak intensity A1 at a position of about 15.5° in 2θ of an X-ray diffraction spectrum is greater than or equal to about 0.8.

### CROSS-REFERENCE TO RELATED APPLICATION

This application claims priority to Korean Patent Application No. 10-2015-0143522 filed in the Korean Intellectual Property Office on Oct. 14, 2015, the content of which is incorporated herein in its entirety by reference.

### BACKGROUND

1. Field

A window for a display device and a display device including the same are disclosed.

2. Description of the Related Art

Portable display devices such as a smart phone or a tablet PC have been a focus of active research due to their high performance and popularity. For example, a light-weight flexible (i.e., bendable or foldable) portable display device has been studied and developed for commercialization. The portable display device of a liquid crystal display or the like includes a protective window for protecting a display module such as a liquid crystal layer. Currently, most portable display devices include a window including a rigid glass substrate. However, glass is fragile, so when it is applied to a portable display device or the like, the glass can be easily cracked or broken by an exterior impact. Also, glass is not flexible, so it may be not suitable for application in a flexible display device. Therefore, attempts have been attempted to substitute a protective window with a plastic film in a display device. However, it has been difficult to simultaneously achieve desirable flexibility of the plastic film in combination with good mechanical properties (such as hardness and optical properties), which are required for the protective window in a display device. As a result, the attempts to develop the plastic film material as a protective window for a display device have been delayed.

### SUMMARY

An embodiment provides a plastic window for a display device simultaneously having high hardness and excellent optical properties.

Another embodiment provides an electronic device including the window for a display device.

In an embodiment, a window for a display device includes:

a plastic substrate including a poly(imide-amide) copolymer, which is a reaction product of a reagent combination of 4,4′-hexafluoroisopropylidene diphthalic anhydride, 3,3′,4,4′-biphenyltetracarboxylic dianhydride, 2,2′-bis-trifluoromethyl-4,4′-biphenyldiamine, and terephthaloyl chloride (TPCl), and

a hard coating layer disposed on at least one side of the plastic substrate,

wherein the plastic substrate has pencil scratch hardness of greater than or equal to 3H when measured according to an ASTM D3363 standard at a vertical load of about 0.5 kilograms, and

a peak intensity ratio A2/A1 of a peak intensity A2 at a position of about 23.5° in 2θ to a peak intensity A1 at a position of about 15.5° in 2θ of an X-ray diffraction spectrum is greater than or equal to about 0.8.

The plastic substrate has a yellowness index of less than or equal to about 3.5 when measured according to an ASTM D1925 standard.

The plastic substrate has a yellowness index increased of less than or equal to about 1 after UV radiation for about 72 hours.

The plastic substrate may have a peak intensity ratio A2/A1 of greater than or equal to about 0.9.

The plastic substrate may have a peak intensity ratio A2/A1 of greater than or equal to about 1.0.

The plastic substrate may have a peak intensity ratio A2/A1 of greater than or equal to about 1.1.

The plastic substrate may have a peak intensity ratio A2/A1 of greater than or equal to about 1.2.

The mole ratio of 2,2′-bis-trifluoromethyl-4,4′-biphenyldiamine to terephthaloyl chloride to combined 3,3′,4,4′-biphenyltetracarboxylic dianhydride and 4,4′-hexafluoroisopropylidene diphthalic anhydride in the reagent combination may be about 1:(about 0.2 to about 0.8):(about 0.8 to about 0.2).

The mole ratio of 3,3′,4,4′-biphenyltetracarboxylic dianhydride and 4,4′-hexafluoroisopropylidene diphthalic anhydride in the reagent combination may be (about 0.2 to about 0.8):(about 0.8 to about 0.2).

The mole ratio of 3,3′,4,4′-biphenyltetracarboxylic dianhydride and 4,4′-hexafluoroisopropylidene diphthalic anhydride in the reagent combination may be (about 0.4 to about 0.6):(about 0.6 to about 0.4).

The plastic substrate may be obtained by elongating a film of the poly(imide-amide) copolymer in greater than or equal to about 0% at a temperature of less than or equal to about 140° C.

The plastic substrate may be obtained by elongating a film of the poly(imide-amide) copolymer in greater than or equal to about 1% at a temperature of less than or equal to about 140° C.

The plastic substrate may have a thickness of about 25 micrometers to about 100 micrometers. The hard coating layer may include an acrylate polymer, a polycaprolactone, a urethane-acrylate copolymer, a polyrotaxane, an epoxy polymer, a polysilsesquioxane, or a combination thereof.

According to another embodiment, a display device includes the window.

The window may be disposed on a display module of the display device.

### BRIEF DESCRIPTION OF THE DRAWINGS

The above and other advantages and features of this disclosure will become more apparent by describing exemplary embodiments thereof in further detail with reference to the accompanying drawings, in which:

FIG. 1 is a schematic view showing a cross-section of a window for a display device according to an embodiment;

FIG. 2 is a schematic view showing a cross-section of a window for a display device according to another embodiment; and

FIG. 3 is a graph of intensity (number of counts) versus scattering angle (degrees 2 theta), which is an X ray diffraction spectrum of a film obtained from Example 1.

### DETAILED DESCRIPTION

Hereinafter, embodiments are described in detail, and may be readily performed by those who have common knowledge in the related art. However, these embodiments are exemplary, and this disclosure is not limited thereto.

Accordingly, the embodiments are merely described below, by referring to the figures, to explain aspects of the present description. As used herein, the term “and/or” includes any and all combinations of one or more of the associated listed items. The term “or” means “and/or.” Expressions such as “at least one of” when preceding a list of elements, modify the entire list of elements and do not modify the individual elements of the list.

It will be understood that when an element is referred to as being “on” another element, it may be directly on the other element or intervening elements may be present therebetween. In contrast, when an element is referred to as being “directly on” another element, there are no intervening elements present.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer, or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an” and “the” are intended to include the plural forms as well, unless the context clearly indicates otherwise. The term “or” means “and/or.” As used herein, the term “and/or” includes any and all combinations of one or more of the associated listed items. Expressions such as “at least one of,” when preceding a list of elements, modify the entire list of elements and do not modify the individual elements of the list.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system).

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

“Mixture” as used herein is inclusive of all types of combinations, including blends, alloys, solutions, and the like.

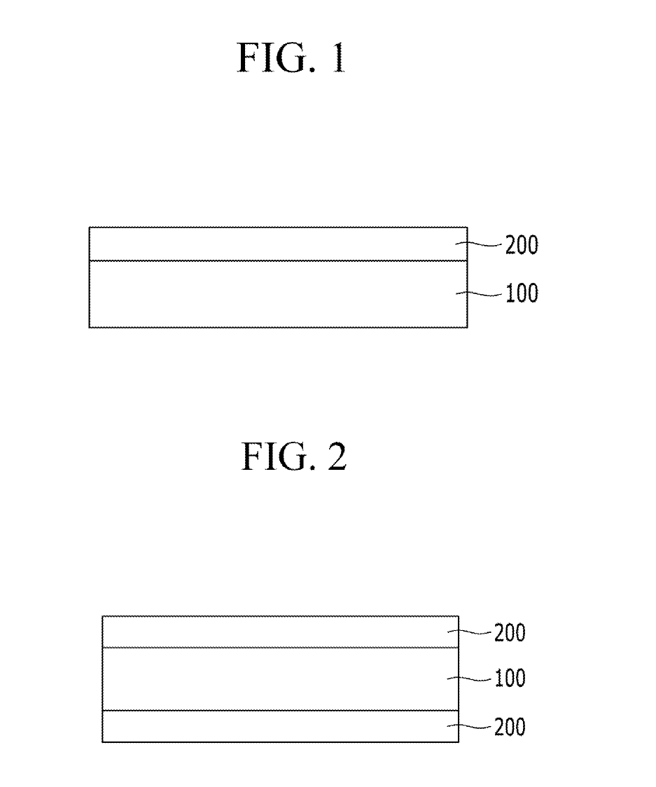

Referring to FIGS. 1 and 2, a structure of a window for a display device according to an embodiment is explained.

In an embodiment, a window for a display device includes:

a plastic substrate 100 including a poly(imide-amide) copolymer prepared from 4,4′-hexafluoroisopropylidene diphthalic anhydride (6FDA), 3,3′,4,4′-biphenyltetracarboxylic dianhydride (BPDA), 2,2′-bis-trifluoromethyl-4,4′-biphenyldiamine (TFDB), and terephthaloyl chloride (TPCI), and

a hard coating layer 200 disposed on at least one side (e.g., one side or both sides) of the plastic substrate 100.

The plastic substrate has pencil scratch hardness of greater than or equal to 3H when measured according to an ASTM D3363 standard at a vertical load of about 0.5 kilograms (kg), and a peak intensity ratio A2/A1 of a peak intensity A2 at a position of about 23.5° in 2θ to a peak intensity A1 at a position of about 15.5° in 2θ of an X-ray diffraction spectrum is greater than or equal to about 0.8.

As a reference for determining whether the window has a high hardness and excellent optical properties, a surface (pencil) hardness and a yellowness index (YI) of the window may be evaluated. A tensile property such as Young's modulus and the like is generally considered as a principal mechanical property of a plastic material included in the window. However, even when the plastic substrate for the window for a display device has a high modulus, its hardness may not be linearly increased when a hard coating layer is employed. Thus, the surface hardness of the substrate may be more important than the modulus for the plastic substrate having a higher than certain level of modulus (e.g., greater than or equal to about 5 gigaPascals, GPa).

For example, when the plastic substrate has a surface pencil hardness of less than or equal to 2H, the display window may fail to provide a desirably high pencil hardness (for example, greater than or equal to 9H) even after employing the hard coating layer. The pencil hardness of the window may be increased by increasing a thickness of the plastic substrate or a thickness of the hard coating layer. However, since it is desirable for the window to have a low thickness for bending and folding of the display module, the thick film is unfavorable. When the plastic substrate having a thickness of about 50 micrometers (μm) has a surface pencil hardness of less than or equal to 2H, the final window may not achieve the surface pencil hardness of 9H even if a hard coating having a thickness of about 50 μm is applied, although it may be different depending on the nature of the hard coating. Furthermore, when an adhesive layer is included under the plastic substrate, or when an OLED module and the like is further included, the desirable level of hardness (e.g., 8H) may not be reached.

The inventors of the present application found that the surface hardness of the plastic substrate is changed according to the chain packing degree of poly(imide-amide) copolymer in the plastic substrate including a poly(imide-amide) copolymer. In other words, it has been determined that the surface hardness may be increased when the chain packing degree of poly(imide-amide) copolymer becomes higher. The chain packing degree of the poly(imide-amide) copolymer may be determined by measuring a relative peak intensity at certain two 2 theta (2θ) positions.

For example, when the plastic substrate including the poly(imide-amide) copolymer prepared from 6FDA, BPDA, TFDB and TPCI has a peak intensity ratio A2/A1 of a peak intensity A2 at a position of about 23.5° in 2θ to a peak intensity A1 at a position of about 15.5° in 2θ of an X-ray diffraction spectrum that is greater than or equal to about 0.8, for example, greater than or equal to about 0.9, for example, greater than or equal to about 1.0, for example, greater than or equal to about 1.1, for example, greater than or equal to about 1.2, it has been determined that the plastic substrate has high surface hardness, for example, pencil scratch hardness of greater than or equal to 3H when measured according to an ASTM D3363 standard at a vertical load of about 0.5 kg.

To increase the chain packing degree of poly(imide-amide) copolymer, one may consider increasing a mole ratio of the amide structural unit in the copolymer. As the mole ratio of the amide structural unit is increased, the chain packing degree may be increased, and as the result, the surface hardness may also be increased.

Accordingly, in an embodiment, the mole ratio of TFDB to TPCL to combined BPDA and 6FDA (BPDA+6FDA) may be about 1:(about 0.2 to about 0.8):(about 0.8 to about 0.2), wherein “about 1” refers to the number of moles of TFDB, “(about 0.2 to about 0.8)” refers to the number of moles of TPCL, and “(about 0.8 to about 0.2)” refers to the combined number of moles of BPDA and 6FDA. In other words, TPCL forming an amide structural unit in the poly(imide-amide) copolymer is included in an amount of about 0.2 to about 0.8 moles based on the amount of TFDB and reacted with the same number of moles of TFDB, so as to provide an amide structural unit in about 0.2 moles to about 0.8 moles, and the remaining imide structural unit in an amount of about 0.8 moles to about 0.2 moles based on 1 mole of the poly(imide-amide) copolymer.

In addition, a mole ratio of BPDA and 6FDA forming an imide structural unit in the poly(imide-amide) copolymer may be (about 0.2 to about 0.8):(about 0.8 to about 0.2), for example, (about 0.4 to about 0.6):(about 0.6 to about 0.4).

Among the dianhydride components forming an imide structural unit, BPDA has a more rigid structure than 6FDA, since two phenylene rings are connected by a single bond. Thus, when BPDA is included within the above ranges, it may further enhance the mechanical strength of the poly(imide-amide) copolymer, that is, a surface pencil hardness of the plastic substrate including the poly(imide-amide) copolymer.

Among the dianhydride components forming an imide structural unit, 6FDA is structurally flexible compared to the BPDA, since two phenylene rings are connected by 2,2-bis-trifluoromethyl group-substituted methylene group. When 6FDA is included within the above ranges, it may further increase a transparency of the plastic substrate, as a yellowness index of the plastic substrate including the poly(imide-amide) copolymer decreases.

Meanwhile, when the content of the amide structural unit is increased in the poly(imide-amide) copolymer, it may increase an effective surface hardness due to increase in the chain packing, but it also tends to increase the yellowness index due to increase in the amide content. However, when a peak intensity ratio A2/A1 of a peak intensity A2 at a position of about 23.5 in 2θ to a peak intensity A1 at a position of 15.5° in 2θ of a X-ray diffraction spectrum of plastic substrate including the poly(imide-amide) copolymer is greater than or equal to 0.8, the substrate has a yellowness index of less than or equal to about 3.5 when measured according to an ASTM E1925 standard, which is a satisfactorily appropriate level for a window used in a display device.

In other words, when a peak intensity ratio A2/A1 of a peak intensity A2 at a position of about 23.5 in 2θ to a peak intensity A1 at a position of about 15.5° in 2θ of a X-ray diffraction spectrum of plastic substrate is about 0.8, as a chain packing is increased, the plastic substrate may satisfy the pencil scratch hardness of greater than or equal to about 3H as well as a low yellowness index of less than or equal to about 3.5, so the plastic substrate may attain desirable optical and mechanical characteristics for a window of a display device.

Furthermore, the plastic substrate has a YI increase of less than or equal to about 1 after the ultraviolet (UV) exposure for 72 hours. That is, it has excellent ultraviolet (UV) resistance to UV.

Meanwhile, other method of increasing the chain packing includes a method of elongating a film of poly(imide-amide) copolymer in greater than or equal to 0% at less than or equal to about 140° C.

The poly(imide-amide) copolymer film may be generally obtained by:

reacting monomers for forming an imide structural unit and an amide structural unit in a solvent to provide a poly(imide-amide) copolymer solution;

solvent-casting the solution on a belt substrate or the like to provide a belt film having an elongated length in a length direction of the belt substrate;

separating the belt film from the belt substrate; and

heating the belt film to provide a cured film roll, but it is not limited thereto.

The providing a film roll cured by heating the belt film may include heating the film at a temperature of about 150° C. to 500° C., for example, about 300° C. to 450° C. when the belt film is connected to the tenter, and elongating the belt film before introducing or after introducing into the tenter.

The elongating may be performed at an elongation rate of greater than or equal to about 0%, that is, at a surface stretching ratio of greater than or equal to about 1 (surface stretching ratio is defined as a ratio of a membrane area after the elongation to a membrane area before the elongation; when the elongation rate is 0% (i.e., when the film is not elongated), the surface stretching ratio is 1, and when the elongation rate is less than 0%, the surface stretching ratio is less than 1, and the film is negatively elongated or shrunk).

As understood from Examples and Comparative Examples described below, the film including a copolymer of the same composition elongated in 2% (Example 1) has higher increased surface hardness compared to the film which is not elongated (Example 2).

On the other hand, when the poly(imide-amide) copolymer having the same composition is heat-treated while elongated in −1% (i.e., the polymer is negatively elongated or shrunk (Comparative Example 2), the surface hardness is significantly deteriorated.

Likewise, the surface hardness of plastic substrate including poly(imide-amide) copolymer may be estimated according to the chain packing degree of poly(imide-amide) copolymer, so the desired window for a display device having a higher surface hardness may be provided.

Meanwhile, the poly(imide-amide) copolymer may be prepared by reacting a monomer forming an imide structural unit, which is diamine (TFDB) and dianhydride (BPDA and/or 6FDA), with a monomer for forming an amide structural unit, which is diamine (TFDB) and diacyl dichloride (TPCL). However, according to an embodiment, the poly(imide-amide) copolymer may be prepared by first reacting TFDB for forming an amide structural unit with TPCL to provide an amide oligomer; and subsequently reacting the amide oligomer with a monomer for forming an imide structural unit, which is TFDB and BPDA+6FDA to provide a poly(imide-amide) copolymer. In this embodiment, the conventional precipitation process for removing HCl (which is a side product generated while forming an amide structural unit) is not required, and there is no salt generated from HCl, so a poly(imide-amide) copolymer including a higher content of amide structural unit is provided. By including a higher content of the amide structural unit, the mechanical strength, which is a surface hardness, of the plastic substrate including the corresponding poly(imide-amide) copolymer, as mentioned above, may be further enhanced. Accordingly, an embodiment may provide a plastic substrate including a poly(imide-amide) copolymer, in which the content of the amide structural unit is increased up to about 80 mole percent (mol %).

The window for a display device according to an embodiment includes the plastic substrate having pencil scratch hardness of greater than or equal to 3H when measured according to an ASTM D3363 standard at a vertical load of about 0.5 kg, and a peak intensity ratio A2/A1 of a peak intensity A2 at a position of about 23.5° in 2θ to a peak intensity A1 at a position of about 15.5° in 2θ obtained from an X-ray diffraction spectrum, which is greater than or equal to about 0.8, and simultaneously, having a film yellowness index thereof when measured according to an ASTM D1925 standard, which is less than or equal to about 3.5. While not wishing to be bound by theory, it is understood that when the plastic substrate has such properties, the resultant window has strong scratch resistance and transparency.

The plastic substrate may have a thickness of less than or equal to about 100 μm, for example, about 25 μm to about 100 μm. While not wishing to be bound by theory, it is understood that when the plastic substrate has a thickness within the above ranges, the desired yellowness index and surface hardness may be obtained.

The window for a display device includes a hard coating layer on one side or both sides of the plastic substrate. The hard coating layer may have a multi-layered structure of one or more layers. The hard coating layer heightens the surface hardness of the window. When the glass plate is used as a test plate, the hard coating layer may have a hardness of greater than or equal to about 1 H, for example, greater than or equal to about 8H measured at a vertical load of about 1 kg according to an ASTM D3363 standard. When the hard coating layer is included, the window for a display device according to an embodiment may have a hardness of greater than or equal to about 7H, for example, greater than or equal to about 9H. As a material for forming a hard coating layer (i.e., a hard coating material), the thermal-curable or photo-curable material may be used. Examples of the material may be an acrylate polymer, a polycaprolactone, a urethane-acrylate copolymer, a polyrotaxane, an epoxy polymer, an organosilicon material such as silsesquioxane, and an inorganic hard coating material such as silica, but are not limited thereto. The acrylate polymer may be a polymer of a monomer combination (for example, a mixture) including multi-functional acrylate monomers. Examples of the multi-functional acrylate monomer may be trimethylolpropane triacrylate (TMPTA), trimethylolpropane ethoxy triacrylate (TMPEOTA), glycerine propoxylated triacrylate (GPTA), pentaerythritol tetraacrylate (PETA), and dipentaerythritol hexaacrylate (DPHA), but are not limited thereto. The urethane acrylate material and the multi-functional acrylate material have excellent adherence and high productivity.

The window for a display device according to an embodiment has excellent mechanical properties such as high rigidity and tensile strength, and simultaneously has good optical properties such as a low yellowness index. Particularly, when a glass substrate is not utilized, the window is light in weight and has high flexibility, so it can be used in a flexible display.

In another embodiment, a display device including the window is provided.

The window may be disposed on a display module of the display device. The display module may be a liquid crystal display module, an organic light emitting display module, a plasma display module, an electric field effect display module, an electrophoretic display module, and the like, but is not limited thereto.

Hereafter, this disclosure is described in detail with reference to examples. However, the following examples and comparative examples are not restrictive, but are illustrative.

### Examples

### Synthesis Example 1: Preparation of Poly(imide-amide) Copolymer

63 kilograms (kg) of dimethyl acetamide is placed into a reactor and 907 g of pyridine is added thereto under the nitrogen atmosphere. 3,671 grams (g) of 2,2′-bistrifluoromethyl-4,4′-biphenyldiamine (TFDB) is placed into the reactor and dissolved to provide a TFDB solution. 1,164 g of terephthaloyl chloride (TPCI) is added into the TFDB solution and agitated at 30° C. for 3 hours to provide an amide oligomer solution. The obtained solution is precipitated using water and dried at 80° C. for 48 hours to provide amide oligomer powder. 4,500 g of the obtained amide oligomer powder, 1,375 g of 4,4′ hexafluoroisopropylidene diphthalic anhydride (6FDA), and 775 g of 3,3′,4,4′-biphenyltetracarboxylic dianhydride (BPDA) are added to 37.6 kg of dimethyl acetamide and reacted at 30° C. for 48 hours to provide a poly(amic acid-amide) copolymer solution.

1,173 g of acetic anhydride is placed into the obtained poly(amic acid-amide) solution as a chemical imidization catalyst and agitated for 30 minutes, 1,374 g of pyridine is added thereto, and the reaction mixture is agitated at 30° C. for 24 hours to provide a poly(imide-amide) copolymer solution.

### Synthesis Example 2: Preparation of Poly(imide-amide) Copolymer

128 kg of dimethyl acetamide is placed into a reactor and 2,231 g of pyridine is added thereto under the nitrogen atmosphere. 6,500 g of 2,2′-bis trifluoromethyl-4,4′-biphenyldiamine (TFDB) is placed into the reactor and dissolved to provide a TFDB solution. 2,885 g of terephthaloyl chloride (TPCI) is added into the TFDB solution, and the reaction mixture is agitated at 30° C. for 3 hours to provide an amide oligomer solution. The obtained solution is precipitated using water and dried at 80° C. for 48 hours to provide amide oligomer powder.

9,000 g of the obtained amide oligomer powder, 1,353 g of 4,4′ hexafluoroisopropylidene diphthalic anhydride (6FDA) and 896 g of 3,3′,4,4′-biphenyltetracarboxylic dianhydride (BPDA) are added to 59 kg of dimethyl acetamide and reacted at 30° C. for 48 hours to provide a poly(amic acid-amide) copolymer solution.

1,865 g of acetic anhydride is placed into the obtained poly(amic acid-amide) solution as a chemical imidization catalyst, and the reaction mixture is agitated for 30 minutes. 1,445 g of pyridine is added thereto, and the reaction mixture is further agitated at 30° C. for 24 hours to provide a poly(imide-amide) copolymer solution.

### Comparative Synthesis Example 1: Preparation of Polyimide

Under the nitrogen atmosphere, 5,500 g of 2,2′-bistrifluoromethyl-4,4′-biphenyldiamine (TFDB), 6,103 g of 4,4′ hexafluoroisopropylidene diphthalic anhydride (6FDA), and 1,011 g of 3,3′,4,4′-biphenyltetracarboxylic dianhydride (BPDA) are completely dissolved in 53.3 kg of dimethyl acetamide in a reactor. The clear solution is then reacted at 30° C. for 36 hours to provide a polyamic acid solution.

5,260 g of acetic anhydride is placed into the obtained polyamic acid solution as a chemical imidization catalyst, and the reaction mixture is agitated for 30 minutes. 4,075 g of pyridine is added thereto, and the reaction mixture is further agitated at 30° C. for 24 hours to provide a polyamide solution.

### Example 1: Preparation of Poly(imide-amide) Copolymer Film

The poly(imide-amide) copolymer solution obtained from Synthesis Example 1 is discharged from a die, casted on a support, dried on a belt heated at 110° C. for 10 minutes, and delaminated.

The obtained film is elongated in 2% at a tenter inlet maintained at less than or equal to 140° C. and passed through a tenter first region (retaining time: 2.5 minutes, elongated in 0%) maintaining at 140° C., then sequentially passed through a second region (retaining time: 2.5 minutes, elongated in −1%) maintaining at 240° C., and a third region (retaining time: 2.5 minutes, elongated in 0%) maintaining at 310° C. to provide a final cured film.

### Example 2: Preparation of Poly(imide-amide) Copolymer Film

A final cured film is obtained in accordance with the same procedure as in Example 1, except that the poly(imide-amide) copolymer solution obtained from Synthesis Example 1 is not elongated (i.e., 0% elongated) at a tenter inlet maintained at less than or equal to 140° C. and sequentially passed through the first region to the third region of a tenter.

### Example 3: Preparation of Poly(imide-amide) Copolymer Film

A final cured film is obtained in accordance with the same procedure as in Example 2, except that the poly(imide-amide) copolymer solution obtained from Synthesis Example 2 is used instead of the poly(imide-amide) copolymer solution obtained from Synthesis Example 1.

### Comparative Example 1: Preparation of Polyimide Film

A final cured film is obtained in accordance with the same procedure as in Example 2, except that the polyimide solution obtained from Comparative Synthesis Example 1 is used instead of the poly(imide-amide) copolymer solution obtained from Synthesis Example 1.

### Comparative Example 2: Preparation of Poly(imide-amide) Copolymer Film

A final cured film is obtained in accordance with the same procedure as in Example 1, except that the poly(imide-amide) copolymer solution obtained from Synthesis Example 1 is elongated in a rate of −1% (i.e., negatively elongated or shrunk) at a tenter inlet.

### Evaluation of the Obtained Film

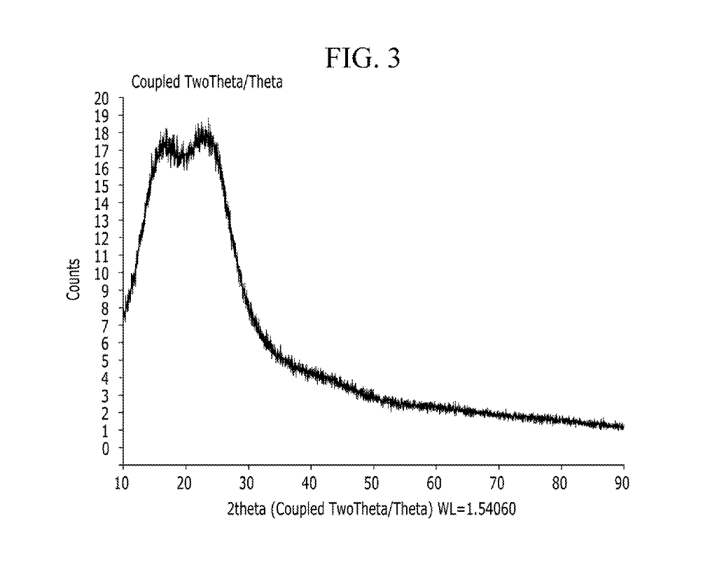

The thickness and pencil hardness values, yellowness indexes, and yellowness index differences after UV radiation for 72 hours of the films obtained from Example 1 to Example 3 and Comparative Example 1 and Comparative Example 2 are measured, and A2/A1 values (A2 is a peak intensity at 2θ=˜23.5°, A1 is a peak intensity at 2θ=˜15.5° are calculated from the X ray diffraction spectrum after measuring the peaks. The results are shown in Table 1. FIG. 3 shows a X ray diffraction spectrum for a film according to Example 1.

[1] Thickness Measurement

Measured using a Micrometer (manufactured by Mitutoyo).

[2] Pencil Hardness

Using a pencil hardness measurer and a Mitsubishi pencil, a pencil scratch hardness is measured according to an ASTM D3363 standard. Specifically, the film is fixed on a glass plate having a thickness of about 2 millimeters (mm) and measured at a vertical load of about 0.5 kg and at a pencil speed of about 60 millimeters per minute (mm/min) in each 20 mm for 5 times, and thereafter, the highest hardness with no scars is determined.

[3] Yellowness Index (YI)

Using a UV Spectrophotometer (manufactured by Konica Minolta, cm-3600d), yellowness index is measured according to an ASTM D1925 standard.

[4] Yellowness Index (ΔYI) after UV Radiation

The plastic substrate is exposed to an ultraviolet (UV) lamp having a UVB wavelength region for 72 hours (greater than or equal to 200 milliJoules per square centimeter, mJ/cm²) and a yellowness index difference is measured before and after the exposure (after UV radiation-before UV radiation).

[5] A2/A1

After obtaining an X ray diffraction spectrum of the film, two peaks are separated as a Gaussian Function at 2θ=˜23.5°, 2θ=˜15.5° (referring to the following Equation 1).

A peak is separated, and the intensity of each peak is measured. In each drawing, the intensity of each peak (A1 and A2) and A2/A1 are calculated, and the results are shown in Table 1: Equation 1

$$y = {y}_{0} + A {e}^{- \frac{{( x - {x}_{c} )}^{2}}{2 {w}^{2}}}$$

In the Equation 1,

y refers to a vertical axis which is an intensity;

y₀ is offset which is a baseline intensity;

x refers to a horizontal axis which is 28;

x_{c} refers to 2θ at a center;

w refers to a peak width; and

A refers to a peak amplitude.

TABLE 1

| | Poly(imide-amide) | | | | | | | |
|---|---|---|---|---|---|---|---|---|
| | copolymer or | Thickness | Pencil | | | | | |
| | polyimide | (μm) | hardness | YI | ΔYI | A1 | A2 | A2/A1 |
| Example 1 | Synthesis | 50 | 4H | 2.9 | 0.5 | 1020.31 | 1256.57 | 1.24 |
| | Example 1 | | | | | | | |
| Example 2 | Synthesis | 50 | 3H | 3.5 | 0.4 | 1476.13 | 1235.59 | 0.84 |
| | Example 1 | | | | | | | |
| Example 3 | Synthesis | 40 | 3H | 3.3 | 0.6 | 1056.15 | 957.27 | 0.91 |
| | Example 2 | | | | | | | |
| Comparative | Comparative | 50 | 2B | 2.5 | 0.6 | 949.75 | 279.79 | 0.29 |
| Example 1 | Synthesis | | | | | | | |
| | Example 1 | | | | | | | |
| Comparative | Synthesis | 50 | H | 3.3 | 0.6 | 1406.47 | 1111.94 | 0.79 |
| Example 2 | Example 1 | | | | | | | |

Referring to Table 1, it is determined that the films according to Example 1 to Example 3, in which a rate of dividing a peak intensity A2 at a position of about 23.5° in 2θ by a peak intensity A1 at a position of about 15.5° in 2θ of an X ray diffraction spectrum is greater than or equal to about 0.8, satisfy the pencil hardness of greater than or equal to about 3H and YI of less than or equal to about 3.5 at a thickness of about 50 μm. Particularly, in Examples 1 and 2, both including the poly(imide-amide) copolymers obtained from Synthesis Example 1 have the same composition. In Example 1, the film is elongated in 2%, and a chain packing is increased, and thus, the A2/A1 ratio is also increased compared to Example 2, in which the film is elongated in 0%, so that the mechanical strength of the resulting poly(imide-amide) in Example 1 is remarkably increased.

The film according to Comparative Example 1 including only a polyimide containing no amide structural units, has a low yellowness index but also has a substantially low surface hardness of 2B to be used as a plastic substrate in a window.

The film according to Comparative Example 2, including the poly(imide-amide) copolymer obtained from Synthesis Example 1 as in Example 1 and Example 2, is elongated in less than 0%, which is negative elongation, so a chain packing degree is decreased, and as a result, a peak intensity ratio A2/A1 of a peak intensity A2 at a position of about 23.5° in 2θ to a peak intensity A1 at a position of about 15.5° in 2θ of an X ray diffraction spectrum is also decreased to less than about 0.8, so the pencil hardness is significantly decreased to 1 H.

In other words, even when the poly(imide-amide) copolymer having the same composition is used, the surface hardness of the film may be changed according to the chain packing degree; and the chain packing degree may be easily verified by measuring an X ray diffraction spectrum of the obtained film and comparing two peak values at certain 2θ positions.

Likewise, the film including poly(imide-amide) copolymer according to an embodiment has a high surface hardness, a low yellowness index, and a small change of yellowness index after UV radiation for 72 hours, so when it is used as a plastic substrate and further coated with a hard coating layer for protecting the window surface for a display device, it may ensure a desirable surface hardness (scratch resistance) and a low yellowness index.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A window for a display device comprising:
a plastic substrate comprising a poly(imide-amide) copolymer, which is a reaction product of a reagent combination of 4,4′-hexafluoroisopropylidene diphthalic anhydride, 3,3′,4,4′-biphenyltetracarboxylic dianhydride, 2,2′-bis-trifluoromethyl-4,4′-biphenyldiamine, and terephthaloyl chloride, and
a hard coating layer disposed on at least one side of the plastic substrate,
wherein the plastic substrate has pencil scratch hardness of greater than or equal to 3H measured according to an ASTM D3363 standard at a vertical load of about 0.5 kilograms, and
a peak intensity ratio A2/A1 of a peak intensity A2 at a position of about 23.5° in 2θ to a peak intensity A1 at a position of about 15.5° in 2θ of an X-ray diffraction spectrum is greater than or equal to about 0.8.

2. The window for a display device of claim 1, wherein the plastic substrate has a yellowness index of less than or equal to about 3.5 when measured according to ASTM D1925 standard.

3. The window for a display device of claim 1, wherein the plastic substrate has a yellowness index increase of less than or equal to about 1 after UV radiation for 72 hours.

4. The window for a display device of claim 1, wherein the plastic substrate has a peak intensity ratio A2/A1 of greater than or equal to about 0.9.

5. The window for a display device of claim 1, wherein the plastic substrate has a peak intensity ratio A2/A1 of greater than or equal to about 1.0.

6. The window for a display device of claim 1, wherein the plastic substrate has a peak intensity ratio A2/A1 of greater than or equal to about 1.1.

7. The window for a display device of claim 1, wherein the plastic substrate has a peak intensity ratio A2/A1 of greater than or equal to about 1.2.

8. The window for a display device of claim 1, wherein a mole ratio of 2,2′-bis-trifluoromethyl-4,4′-biphenyldiamine to terephthaloyl chloride to combined 3,3′,4,4′-biphenyltetracarboxylic dianhydride and 4,4′-hexafluoroisopropylidene diphthalic anhydride in the reagent combination is about 1:(about 0.2 to about 0.8):(about 0.8 to about 0.2).

9. The window for a display device of claim 1, wherein a mole ratio of 3,3′,4,4′-biphenyltetracarboxylic dianhydride and 4,4′-hexafluoroisopropylidene diphthalic anhydride in the reagent combination is (about 0.2 to about 0.8):(about 0.8 to about 0.2).

10. The window for a display device of claim 9, wherein a mole ratio of 3,3′,4,4′-biphenyltetracarboxylic dianhydride and 4,4′-hexafluoroisopropylidene diphthalic anhydride in the reagent combination is (about 0.4 to about 0.6):(about 0.6 to about 0.4).

11. The window for a display device of claim 1, wherein the plastic substrate is obtained by elongating a film of the poly(imide-amide) copolymer in greater than or equal to about 0% at a temperature of less than or equal to about 140° C.

12. The window for a display device of claim 1, wherein the plastic substrate is obtained by elongating a film of the poly(imide-amide) copolymer in greater than or equal to about 1% at a temperature of less than or equal to about 140° C.

13. The window for a display device of claim 1, wherein the plastic substrate has a thickness of about 25 micrometers to about 100 micrometers.

14. The window for a display device of claim 1, wherein the hard coating layer comprises an acrylate polymer, a polycaprolactone, a urethane-acrylate copolymer, a polyrotaxane, an epoxy polymer, a polysilsesquioxane, or a combination thereof.

15. A display device comprising the window of claim 1.
